(19) United States
(12) Patent Application Publication
(10) Pub. No.: US 2008/0137615 A1
(43) Pub. Date: Jun. 12, 2008

(54) METHOD OF SETTING L3 HANDOVER PATH GUARANTEEING FLOW-BASED QoS IN MOBILE IPv6 NETWORK

(75) Inventors: Chang Min PARK, Daejeon-City (KR); Sung Hei KIM, Daejeon-City (KR); Yoon Young AN, Daejeon-City (KR); Tae Il KIM, Daejeon-City (KR); Hae Won JUNG, Daejeon-City (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-City (KR)

(21) Appl. No.: 11/952,782

(22) Filed: Dec. 7, 2007

(30) Foreign Application Priority Data
Dec. 8, 2006 (KR) 10-2006-0125138

(51) Int. Cl. H04Q 7/00

(52) U.S. Cl. 370/332

(57) ABSTRACT

Provided is a method of setting a layer 3 (L3) handover path in a mobile IPv6 (Internet Protocol Version 6) network while guaranteeing a flow-based QoS (Quality of Service). The method includes receiving verification of QoS-related information and flow information of a mobile terminal in a home network from a network management system, constructing a flow list storing the verified flow information in the mobile terminal, and constructing a flow cache storing the verified flow information in an access router in the home network; transmitting the flow information by using a hop-by-hop extension header of a packet that is to be transmitted in order to allow a plurality of routers in a path between the mobile terminal and a correspondent terminal to sequentially construct a flow cache; if the mobile terminal moves to a target network, reconstructing the flow list of the mobile terminal and the flow cache in the access router in the target network, between the mobile terminal and an access router of the target network; adding the hop-by-hop extension header to a binding update message in order to allow a plurality of routers in a path between the mobile terminal which has moved to the target network and the access router in the home network to sequentially construct the flow cache; and adding the hop-by-hop extension header to a binding update message in order to allow a plurality of routers in a path for establishing direct communication between the mobile terminal and the correspondent terminal to sequentially construct the flow cache.

### CROSS-REFERENCE TO RELATED PATENT APPLICATIONS

This application claims the benefit of Korean Patent Application No. 10-2006-0125138, filed on Dec. 8, 2006, in the Korean Intellectual Property Office, the disclosure of which is incorporated herein in its entirety by reference.

### BACKGROUND OF THE INVENTION

1. Field of the Invention

The present invention relates to a method of setting a layer-3 (L3) handover path guaranteeing flow-based Quality of Service (QoS), and more particularly, to a method of setting an L3 handover path in a mobile Internet service network environment supporting mobile services for an Internet Protocol Version 6 (IPv6)-based terminal, so that IPv6-based mobile services can be performed while guaranteeing flow-based QoS.

This work was supported by the IT R&D program of MIC/IITA [2006-S-061-01, R&D on Router Technology for IPv6 based QoS Services and Host Mobility].

2. Description of the Related Art

Since the present invention has two aspects of providing mobile services and providing Quality of Service (QoS), the prior art related to both aspects will now be described.

Conventional methods of providing mobile terminal services based on a layer-3 (L3) protocol that is an Internet protocol (IP) are largely categorized into two methods. One of the methods is an Internet Protocol Version 4 (IPv4)-based mobile Internet service that is an IPv4-based mobile terminal service, and the other method is an Internet Protocol Version 6 (IPv6)-based mobile Internet service that is an IPv6-based mobile terminal service. The two methods respectively provide only L3 handover services via a mobile terminal in an IPv4-based network and in an IPv6-based network but both of them do not consider provision of QoS.

That is, a network supporting IPv6-based terminal mobility provides a solution to a discontinuity in routing to a correspondent terminal, caused by movement of a mobile terminal to a target network other than a home network, but does not guarantee the QoS.

Also, conventional methods of guaranteeing the QoS in the Internet are largely categorized into two methods: an Integrated Service (IntServ) and a Differential Service (DiffServ). Specifically, in the IntServ, QoS values are transmitted between terminals at both ends via a Resource Reservation Protocol (RSVP) signal, and a resource is reserved in a plurality of routers in a service path by using the QoS values, thereby guaranteeing the QoS. In the DiffServ, service grades are predetermined according to service types and a service grade of a user in a network is guaranteed based on DiffServ Code Point (DSCP) recorded in a Traffic Class field of an IPv6 header.

However, both methods are related to guaranteeing the QoS in a fixed terminal. That is, both of them provide a method of providing QoS without considering terminal mobility and therefore may cause problems in a mobile network.

Although routing equipment for processing a flow-based packet while guaranteeing flow-based QoS has been introduced, the flow-based packet is simply processed by the routing equipment according to a unique method. A flow is a unilateral stream of a packet from a specified transmitter to a specified receiver. The flow is identified by the transmitter's IP address, the transmitter's port number, and the receiver's IP address and port number.

Thus, there is a need to develop a method of providing a mobile terminal with an L3 handover service while guaranteeing the end-to-end flow-based QoS between the mobile terminal and a correspondent terminal. To this end, a path setting method whereby a router capable of processing flow-based packets receives authentication regarding a QoS value of a user terminal for each flow in an access network, extracts information regarding flow-based QoS processing, and then transmits the extracted information to a plurality of routers in a transmission path, is needed.

In detail, there is a need for a method of allowing a router capable of processing flow-based packets to receive authentication regarding QoS values of a mobile terminal for each flow in an access network included in a home network and then changing a path setting process so as to guarantee QoS based on the QoS values during an L3 handover process so that IPv6-based L3 handover services can be provided while guaranteeing end-to-end QoS between the mobile terminal and a correspondent mobile terminal even if the mobile terminal moves to a target network.

### SUMMARY OF THE INVENTION

The present invention provides a path setting method for providing a layer-3 (L3) handover service based on Internet Protocol Version 6 (IPv6) while guaranteeing Quality of Service (QoS) between a mobile terminal and a correspondent terminal, even if the mobile terminal moves from a home network to a target network.

According to an aspect of the present invention, there is provided a method of setting a layer 3 handover path guaranteeing flow-based QoS (quality of service) in a mobile IPv6 (Internet protocol version 6) network, the method comprising receiving verification of QoS-related information and flow information of a mobile terminal in a home network from a network management system, constructing a flow list storing the verified flow information in the mobile terminal, and constructing a flow cache storing the verified flow information in an access router in the home network; transmitting the flow information by using a hop-by-hop extension header of a packet that is to be transmitted in order to allow a plurality of routers in a path between the mobile terminal and a correspondent terminal to sequentially construct a flow cache; if the mobile terminal moves to a target network, reconstructing the flow list of the mobile terminal and the flow cache in the access router in the target network, between the mobile terminal and an access router of the target network; adding the hop-by-hop extension header to a binding update message in order to allow a plurality of routers in a path between the mobile terminal which has moved to the target network and the access router in the home network to sequentially construct the flow cache; and adding the hop-by-hop extension header to a binding update message in order to allow a plurality of routers in a path for establishing direct communication between the mobile terminal and the correspondent terminal to sequentially construct the flow cache.

According to another aspect of the present invention, there is provided a method of constructing flow-based QoS (quality of service) information of a mobile terminal in a home network in order to set a layer 3 handover path to guarantee flow-based QoS in a mobile IPv6 (Internet protocol version 6) network, the method comprising the mobile terminal setting a wireless section resource with a base station in the home network and requesting an access router in the home network to provide the QoS information; the access router in the home network receiving verification of QoS-related information and flow information of the mobile terminal from a network management system in the home network; constructing a flow cache storing the verified flow information in the access router in the home network; and constructing a flow list storing the verified flow information in the mobile terminal.

Each of the flow cache and the flow list may further comprise a timer value for maintaining flow information for each session.

According to another aspect of the present invention, there is provided a method of setting a QoS (quality of service) path between a mobile terminal and a correspondent terminal in a home network by using flow information in order to set a layer 3 handover path guaranteeing flow-based QoS in a mobile IPv6 (Internet protocol version 6), the method comprising the mobile terminal adding a hop-by-hop extension header to a data packet that is to be transmitted and then providing flow information of the mobile terminal to a router between the mobile terminal and the correspondent terminal; the router receiving the data packet determining whether it is possible to provide a flow-based QoS guarantee that the mobile terminal requests; and if the flow-based QoS guarantee is to be provided, the router transmitting the data packet to a router at a next hop and constructing a flow cache storing the flow information.

The method may further include if the flow-based QoS guarantee is not to be provided, transmitting an error message to the access router in the home network in order to remove the flow cache from a plurality of routers in a path between the mobile terminal and the access router in the home network; and the mobile terminal removing the flow list storing the flow information. The error message may be an ICMPv6 (Internet Control Message Protocol for IPv6) message.

According to another aspect of the present invention, there is provided a method of generating flow-based QoS (quality of service) information of a mobile terminal which has moved to a target network in order to set a layer 3 handover path guaranteeing flow-based QoS in a mobile IPv6 (Internet protocol version 6) network, the method comprising the mobile terminal reconstructing a flow list storing flow information if an access router in a home network allocates a CoA (Care of Address) is allocated to the mobile terminal; the mobile terminal setting a wireless section resource with a base station in the target network and requesting an access router in the target network to provide QoS information; and if the access router in the target network is to provide flow-based QoS, the access router in the target network informing the mobile terminal that the QoS information is recognized, and then constructing a flow cache storing the flow information.

The method may further include if flow-based QoS is not to be provided, the access router in the target network transmitting an error message to the mobile terminal in the target network in order to remove the flow cache from a plurality of routers in a path between the mobile terminal and the access router in the target network; and the mobile terminal removing the flow list storing the flow information. The error message may be an ICMPv6 (Internet Control Message Protocol for IPv6) message.

According to another aspect of the present invention, there is provided a method of setting a QoS (quality of service) path between a mobile terminal in a target network and an access router in a home network by using flow information in order to set a layer 3 handover path for flow-based QoS guarantee in a mobile IPv6 (Internet protocol version 6) network, the method comprising the mobile terminal adding a hop-by-hop extension header to a binding update message and transmitting the binding update message to a router in a path between the mobile terminal in the target network and the access router in the home network so as to deliver flow information of the mobile terminal; the router which has received the binding update message determining whether flow-based QoS that the mobile terminal requests is to be provided; and if the flow-based QoS is to be provided, the router delivering the binding update message to a router at a next hop, and then constructing a flow cache storing the flow information.

The method may further include if the flow-based QoS is not to be provided, delivering an error message to an access router in the target network in order to remove the flow cache from a plurality of routers in a path between the router in the home network and the access router in the target network; and the mobile terminal removing a flow list storing the flow information. The error message may be an ICMPv6 (Internet Control Message Protocol for IPv6) message.

According to another aspect of the present invention, there is provided a method of setting a flow-based QoS (quality of service) path between a mobile terminal and a correspondent terminal in a target network in order to set a layer 3 handover path for flow-based QoS guarantee in a mobile IPv6 (Internet protocol version 6) network, the method comprising the mobile terminal adding a hop-by-hop extension header to a binding update message and transmitting the binding update message to a router in a path between the mobile terminal and the correspondent terminal in the target network in order to deliver flow information of the mobile terminal; the router which has received the binding update message determining whether flow-based QoS that the mobile terminal requests is to be provided; and if the flow-based QoS is to be provided, the router delivering the binding update message to a router at a next hop and then constructing a flow cache storing the flow information.

The method may further include If the flow-based QoS is not to be provided, transmitting an error message to an access router in the target network in order to remove the flow cache from a plurality of routers in a path between the access router in the target network and the router which has received the binding update message, and the mobile terminal removing a flow list storing the flow information. The error message may be an ICMPv6 (Internet Control Message Protocol for IPv6) message.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an Internet Protocol Version 6 (IPv6 ) service network to which the present invention is applied:

FIG. 2 is a diagram illustrating a method of constructing flow-based Quality of Service (QoS) information for a mobile terminal in a home network according to an embodiment of the present invention;

FIG. 3 is a diagram illustrating a method of setting a QoS path between a mobile terminal and a correspondent terminal by using flow information according to an embodiment of the present invention;

FIG. 4 is a diagram illustrating a method of generating flow-based QoS information for a mobile terminal which has moved to a target network, according to an embodiment of the present invention;

FIG. 5 is a diagram illustrating a method of setting a QoS path between a target network and a home agent by using flow information according to an embodiment of the present invention;

FIG. 6 is a diagram illustrating a method of setting a QoS path between a target network and a correspondent terminal by using flow information according to an embodiment of the present invention;

FIG. 7 illustrates the generation of flow information, and construction of a flow list, and a flow cache according to an embodiment of the present invention;

FIG. 8 illustrates various types of a binding cache table available for a mobile IPv6 according to embodiments of the present invention;

FIG. 9 illustrates an extended structure of a data packet according to an embodiment of the present invention;

FIG. 10 illustrates an error message according to an embodiment of the present invention; and

FIG. 11 illustrates the structure of a binding update message according to an embodiment of the present invention.

### DETAILED DESCRIPTION OF THE INVENTION

Exemplary embodiments of the present invention will now be described more fully with reference to the accompanying drawings.

The present invention provides a method of setting a path of a mobile terminal by adding Quality of Service (QoS) information to a signal message during setting of a path for providing a handover service by using a layer-3 (L3)-based mobile Internet protocol (IP) so that the flow-based QoS can be continuously guaranteed, when the mobile terminal moves from an Internet Protocol Version 6 (IPv6)-based network supporting terminal mobility to a target network.

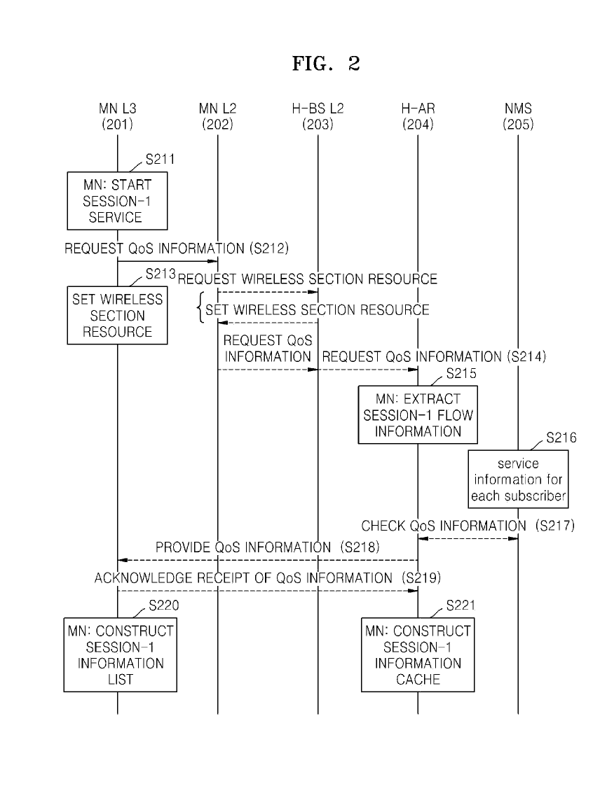

The method according to the present invention is largely categorized into five stages. In a first stage, QoS-related information and flow information regarding a mobile terminal in a home network are verified by a network management system, and then a flow list containing the verified flow information is constructed in the mobile terminal and a flow cache containing the verified flow information is constructed in an access router (see FIG. 2 for details).

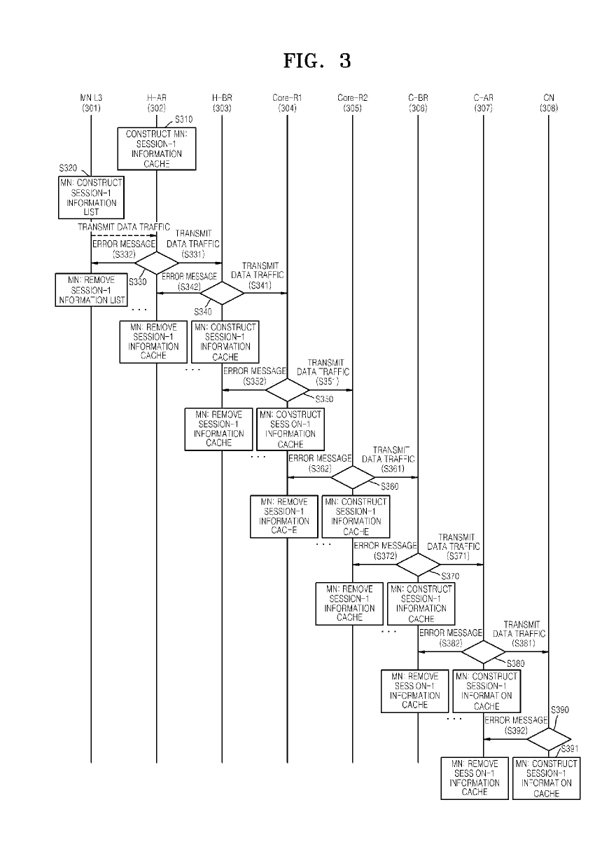

In a second stage, the flow information is transmitted by using a hop-by-hop extension header of a packet that is to be transmitted, and a plurality of routers in a path between the mobile terminal and a correspondent terminal sequentially construct the flow cache (see FIG. 3 for details).

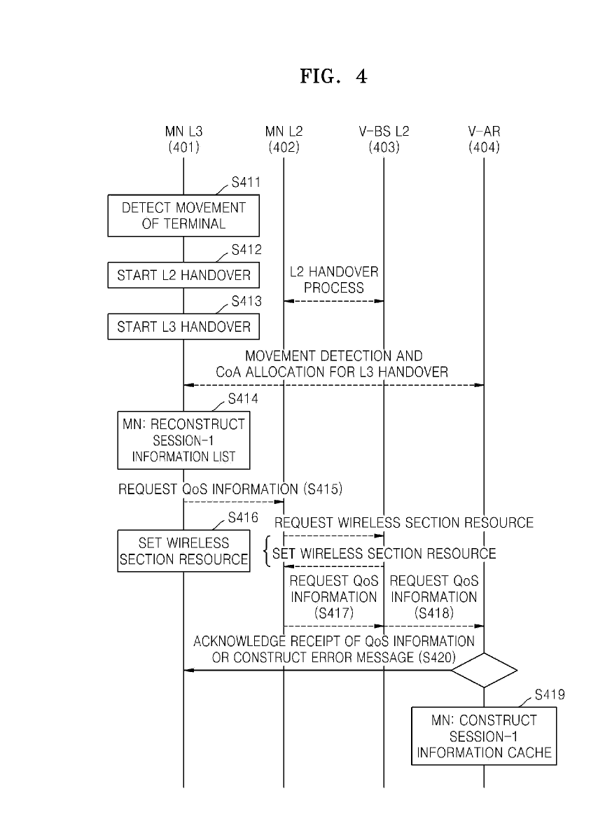

In a third stage, if the mobile terminal moves to a target network, the flow list of the mobile terminal is reconstructed and the flow cache of the access router of the target network is constructed, between the mobile terminal and an access router in the target network (see FIG. 4 for details).

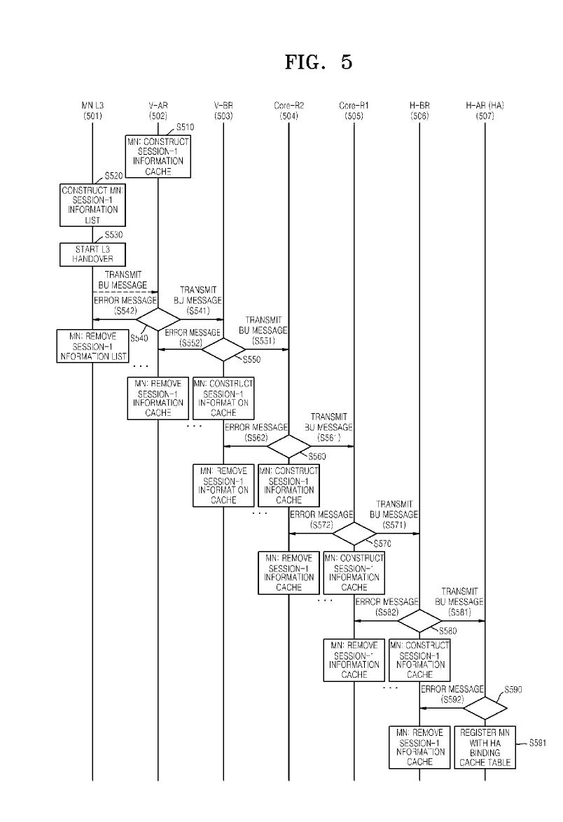

In a fourth stage, the hop-by-hop extension header is added to a binding update (BU) message and then a plurality of routers in a path between the mobile terminal which has moved to the target network and an access router of the home network sequentially construct the flow cache (see FIG. 5 for details)

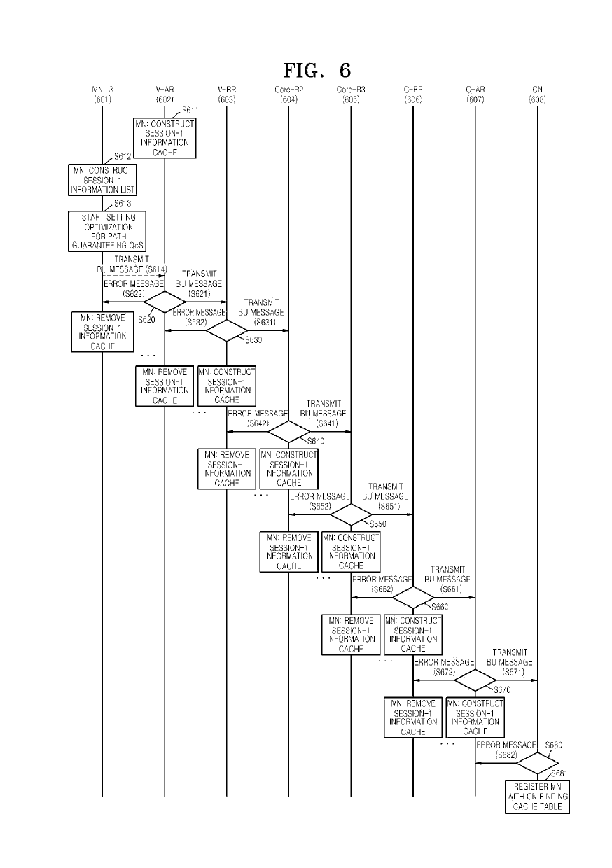

Finally, in a fifth stage, the hop-by-hop extension header is added to a binding update (BU) message and then a plurality of routers in a path for direct communication between the mobile terminal and the correspondent terminal sequentially construct the flow cache (see FIG. 6 for details).

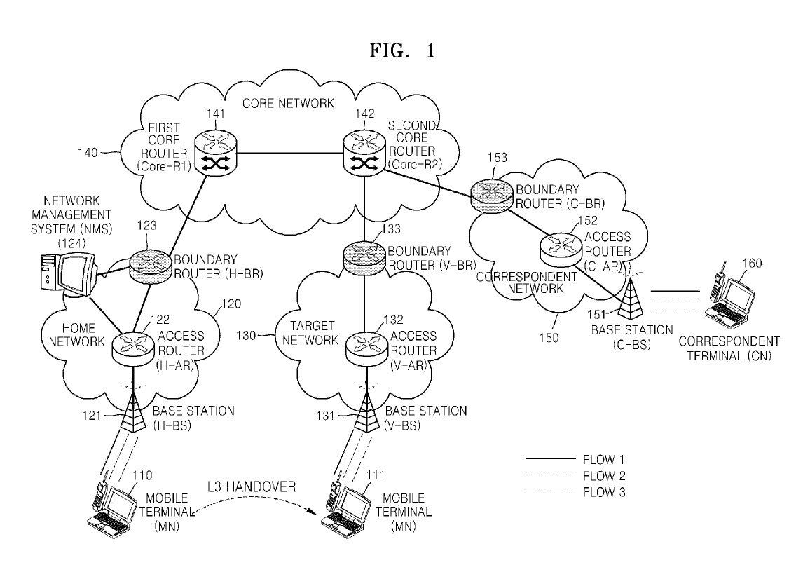

FIG. 1 is a diagram illustrating an IPv6 service network to which the present invention is applied. Referring to FIG. 1, the network includes a plurality of access networks, such as a home network 120, a target network 130, a core network 140, and a correspondent network 150.

The home network 120 is connected to the mobile terminal 110. The target network 130 is a network to which the mobile terminal 111 that is receiving a service moves. The correspondent network 150 is connected to the mobile terminal 110 and the correspondent terminal 160 that is receiving the service. Also, the access networks 120, 130, and 150 are connected via the core network 140.

The access networks 120, 130 and 150 include base stations (BSs) 121, 131, and 151, access routers (ARs) 122, 132, and 152 for wireless access, and boundary routers (BRs) 123,133, and 153 for connection to the core network 140.

If a service having a plurality of flows, such as flows 1 through 3, is produced, the mobile terminal 110 at a sending side and the mobile terminal 160 at a receiving side desire to use the service guaranteeing the flow-based QoS. To this end, the access router 122 in the home network is designed to be capable of processing flow-based packets.

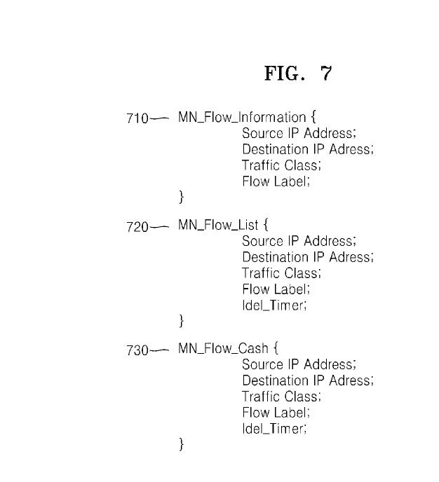

A network management system (NMS) 124 connected to the home network 120 contains flow information 710 for each service of a subscriber terminal (see FIG. 7), which is to be provided to a plurality of service terminals. The NMS are comprised of the routers 122, 123, 132, 133, 141, 142, 152, and 153, which are capable of processing a packet for each flow.

FIG. 2 is a diagram illustrating a method of constructing flow-based QoS information for a mobile terminal in a home network according to an embodiment of the present invention.

In detail, FIG. 2 illustrates a method of constructing flow-based QoS information for a mobile terminal in a home network in order to set an L3 handover path guaranteeing the flow-based QoS in a mobile IPv6 network. In the method, the mobile terminal sets a wireless section resource with a base station in the home network and requests an access router in the home network to provide QoS information; and then the access router in the home network receives verification of QoS-related information and flow information for the mobile terminal from a network management system in the home network, constructs a flow cache storing the verified flow information in the access router in the home network, and constructs a flow list storing the verified flow information in the mobile terminal.

Referring to FIG. 2, if a session service that forms a service flow in an application service for a mobile terminal at a sending side connected to a wireless mobile communication network starts (S211), first, a network layer (L3) 201 of the mobile terminal transmits QoS information to a link layer (L2) 202 of the mobile terminal in order to allocate a wireless network resource (S212). Next, a process of allocating the wireless section resource is performed between the link layer (L2) 202 of the mobile terminal and a base station 203 of a wireless access network (S213).

Then, the base station 203 transmits service traffic to an access router 204 in the home network in order to request QoS information (S214). In response to the request, the access router 204 in the home network extracts flow information (S215). The flow information which is also referred to as session flow information is QoS information for an application service between a terminal that actually transmits a request for a service and a terminal that receives the request. In regard to this, FIG. 7 illustrates the construction of the flow information 710.

A network management system 205 has flow information for each service of a subscriber terminal (S216), and an access router 204 allows the network management system 205 to check the extracted flow information (S217).

After the network management system 205 checks the flow information, the flow information is transmitted to the network layer (L3) 201 of the mobile terminal via the access router 204 in the home network (S218). After receiving the QoS information, the mobile terminal transmits an acknowledgement (ACK) message to the access router 204 (S219), and then constructs a mobile terminal flow list which is session information (S220). The flow list (session flow list) is a data structure in which the flow information is stored in the mobile terminal. FIG. 7 illustrates the construction of a flow list 720.

After receiving the ACK message 219, the access router 204 constructs a session mobile terminal flow cache 221. The flow cache is a data structure in which the flow information is stored in a router and a correspondent terminal. FIG. 7 illustrates the construction of a flow cache 730.

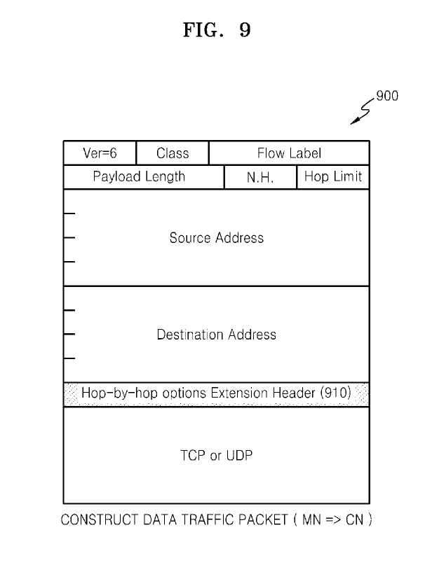

FIG. 3 is a diagram illustrating a method of setting a QoS path between a mobile terminal and a correspondent terminal by using flow information according to an embodiment of the present invention. In detail, FIG. 3 illustrates a method of setting a path guaranteeing QoS by using flow information, a flow list, and a flow cache that have been described above with reference to FIG. 2, if the mobile terminal is located in a home network. The setting of the path guarantees the flow-based QoS even if the mobile terminal moves to a target network. The method will now be described with reference to FIGS. 3 and 9.

In the method of setting a QoS path between a mobile terminal in a home network and a correspondent terminal by using flow information in order to set an L3 handover path guaranteeing the flow-based QoS in a mobile IPv6 network, the mobile terminal transmits flow information of the mobile terminal to a router in a path between the mobile terminal and a correspondent terminal by adding a hop-by-hop extension header to a data packet that is to be transmitted; and then the router receiving the data packet determines whether it is possible to provide flow-based QoS that the mobile terminal requests, transmits the data packet to a router at a next hop when it is determined that the flow-based QoS can be provided and then constructs a flow cache storing the flow information.

Referring to FIG. 3, a QoS path between a mobile terminal 301 (particularly, a network layer of the mobile terminal) in a home network and a correspondent terminal 308 is set by using QoS information obtained as described above with reference to FIG. 2.

More specifically, first, a flow cache is constructed in an access router 302 in a home network according to the method illustrated in FIG. 2 (S310). Next, the mobile terminal 301 in the home network constructs a session flow list by adding a hop-by-hop extension header 910 to a data traffic packet 900 that is to be transmitted, where the hop-by-hop extension header 910 can be processed by all routers in a path between a mobile terminal 301 and correspondent terminal 308 (S320). Then, flow information constituting the session flow list is added to the data traffic packet 900 and the data traffic packet 900 is transmitted.

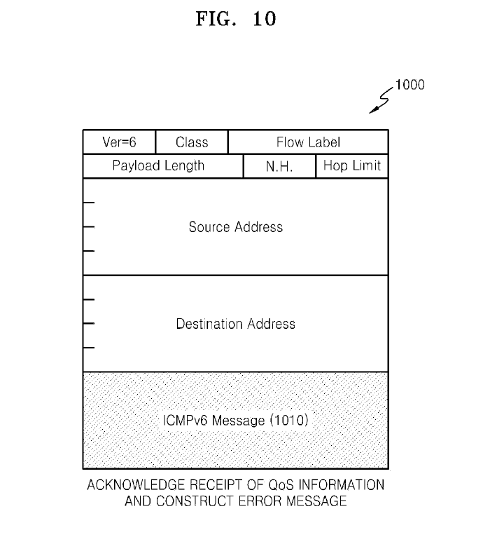

Next, the access router 302 in the home network compares session flow information contained in the hop-by-hop extension header 910 of the data traffic packet 900 with a mobile terminal flow cache stored in the access router 302 (S330). If the session flow information and the mobile terminal flow cache are the same, the access router 302 forwards the data traffic packet 900 to a router at a next hop (S331). If they are not the same, the access router 302 transmits an error message to the mobile terminal 301 (S332). The mobile terminal 301 receiving the error message removes not only the session flow list but also the session flow cache stored in the access router 302. The error message may be an Internet Control Message Protocol for IPv6 (ICMPv6) message, and each network node receiving the error message removes a flow cache and a flow list. The construction of the error message will be described later with reference to FIG. 10.

A boundary router 303 at a next hop in the home network determines whether flow-based QoS can be provided, based on flow information in the hop-by-hop extension header 910 of the data traffic packet 900 verified by the access router 302 (S340). If a resource for providing the QoS is secured, the boundary router 303 constructs a mobile terminal session flow cache in a service session and then transmits the data traffic packet 900 to a next hop (S341). If no resource for the QoS is secured, the boundary router 303 transmits an error message to the access router 302 that is the preceding router in order to remove a mobile terminal flow cache from each router in a path between the mobile terminal 301 and the boundary router 303 and to remove the flow list from the mobile terminal 301 (S342).

Before the data traffic packet 900 is transmitted to a correspondent terminal 308, the manner in which each of the other routers 304, 305, 306, and 307 processes the data traffic packet 900 is the same as the manner in which the boundary router 303 processes the data traffic packet 900. That is, each of the routers 304, 305, 306, and 307 determines whether the QoS can be provided (S350, S360, S370, S380). If the QoS can be provided, each of the routers 304, 305, 306, and 307 constructs a flow cache and transmits the data traffic packet 900 to a subsequent router (S351, S361, S371, S381). If the QoS cannot be provided, each of the routers 304, 305, 306, and 307 transmits an error message in order to remove the flow cache from the preceding routers and the flow list from the mobile terminal 301 (S352, S362, S372, S382).

The correspondent terminal 308 also determines whether the QoS can be provided (S390). If the QoS can be provided, the correspondent terminal 308 constructs a flow list (S391). If the QoS cannot be provided, the correspondent terminal 308 transmits an error message in order to remove the flow cache from the preceding routers and the flow list from the mobile terminal 301 (S392).

Then mobile terminal flow information is generated in all the routers 302 through 307 in the path between the mobile terminal 301 at a sending side and the correspondent terminal 308 at a receiving side, and the correspondent terminal 308.

FIG. 4 is a diagram illustrating a method of constructing flow-based QoS information for a mobile terminal which has moved to a target network, according to an embodiment of the present invention.

In the method of constructing flow-based QoS information for a mobile terminal which has moved to the target network in order to set an L3 handover path for flow-based QoS guarantee in a mobile IPv6 network, if an access router in a home network allocates a Care of Address (CoA) to the mobile terminal, the mobile terminal reconstructs a flow list storing flow information, and sets a wireless section resource together with a base station in the target network and then requests an access router in the target network to provide QoS information; and if the access router in the target network can provide flow-based QoS, the access router informs the mobile terminal that the QoS information is recognized and constructs a flow cache storing flow information.

More specifically, referring to FIG. 4, if a network layer 401 of the mobile terminal senses the movement of the mobile terminal from a home network to a target network (S411), first, an L2 handover is performed between a link layer 402 of the mobile terminal and a base station 403 in the target network (S412) and then an IP layer-based L3 handover starts (S413).

If movement detection and CoA allocation for the L3 handover are performed, a flow list of the mobile terminal is reconstructed (S414).

Then access network QoS information for the target network is requested by using a session flow list stored in the mobile terminal. In detail, first, the mobile terminal transmits QoS information to a link layer 402 of the mobile terminal in order to allocate a wireless section resource (S415). Then the wireless section resource is allocated between the link layer 402 of the mobile terminal and the base station 403 in the target network (S416). After the allocation of the wireless section resource, the link layer 402 of the mobile terminal requests the base station 403 to provide QoS information (S417). Then the base station 403 transmits service traffic to an access router 404 in the target network in order to request the QoS information (S418). If there is a network resource supporting the QoS information, the access router 404 constructs a session flow cache (S419) and then transmits a QoS information ACK message (S420). If there is no network resource supporting the QoS information, the access router 404 transits an error message (S420).

If the construction of the flow-based QoS information (flow cache and flow list) of the mobile terminal in the target network is completed, an L3 handover path guaranteeing the flow-based QoS between the target network and a home agent (not shown) is set using the flow-based QoS information. In general, the home agent is an access router in a home network.

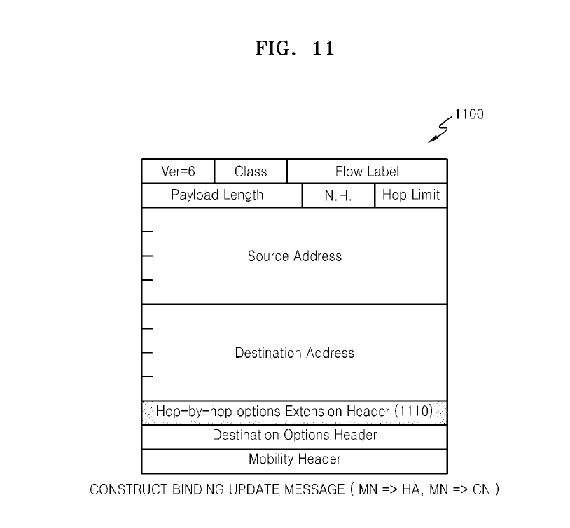

FIG. 5 is a diagram illustrating a method of setting a QoS path between a target network and a home agent by using flow information according to an embodiment of the present invention. In detail, FIG. 5 illustrates a method of setting a path guaranteeing the QoS based on a flow list and a flow cache that are constructed as described above with reference to FIG. 4 when a mobile terminal moves to the target network. The method will now be described with reference to FIGS. 5 and 11.

In the method of setting a QoS path between a mobile terminal in a target network and an access router in a home network by using flow information in order to set an L3 handover path for flow-based QoS guarantee in a mobile IPv6 network, the mobile terminal transmits flow information of the mobile terminal to a router in a path between the mobile terminal in the target network and the access router in the home network by adding a hop-by-hop extension header to a binding update (BU) message; and then the router receiving the BU message determines whether it is possible to provide flow-based QoS that the mobile terminal requests, and then if the flow-based QoS can be provided, the BU message is transmitted to a router at a next hop and a flow cache storing the flow information is constructed.

Referring to FIG. 5, first, a flow cache is constructed in an access router 502 in a target network as described above with reference to FIG. 4 (S510), and a flow list is constructed in a mobile terminal 501 (S520).

The mobile terminal 501 which has moved to the target network is allocated a CoA that is a new address in the target network according to a conventional L3 handover process (S530). In order to provide the CoA to a home agent 507 storing information regarding the location of the mobile terminal 501, a hop-by-hop extension header 1110 is inserted into a BU message 1100 defined in a mobile IPv6 and then the BU message 1100 is transmitted. The hop-by-hop extension header 1110 can be processed by all routers in a path between the mobile terminal 501 and the home agent 507. That is, session flow information constituting the flow list is delivered by adding the hop-by-hop extension header 1110 to the BU message.

The access router 502 in the target network compares the session flow information contained in the hop-by-hop extension header 1110 in the BU message 1100 with the flow information of the flow cache stored in the access router 502 (S540). If the comparison result reveals that the session flow information and the flow information of the flow cache are the same, the access router 502 forwards the BU message to a router at the next hop, i.e., a boundary router 503 in the target network (S541). If the session flow information and the flow information of the flow cache are not the same, the access router 502 transmits an error message to the mobile terminal 501 in order to remove the flow list from mobile terminal 501, and remove the flow cache from the access router 502.

Next, the boundary router 503 determines whether flow-based QoS can be provided, based on the flow information stored in the hop-by-hop extension header 1110 of the BU message verified by the access router 502 (S550). If a resource for providing the QoS is present, a session flow cache in a service session is constructed and the BU message is transmitted to the next hop (S551). If no resource for the QoS is present, the boundary router 503 sends an error message to the preceding router in order to remove the session flow cache from the routers in a path between the mobile terminal 501 and the boundary router 503, and the flow list from the mobile terminal 501 (S552).

The operations of the other routers 504, 505, and 506 are the same as those of the preceding routers. That is, each of the routers 504, 505, and 506 determines whether the QoS can be provided (S560, S570, S580). If the QoS can be provided, each of the routers 504, 505, and 506 constructs a flow cache and transmits the BU message to the following router (S561, S571, S581). If the QoS cannot be provided, each of the routers 504, 505, and 506 transmits an error message to the preceding router in order to remove the flow cache from the preceding routers and the flow list from the mobile terminal 501 (S562, S572, S582).

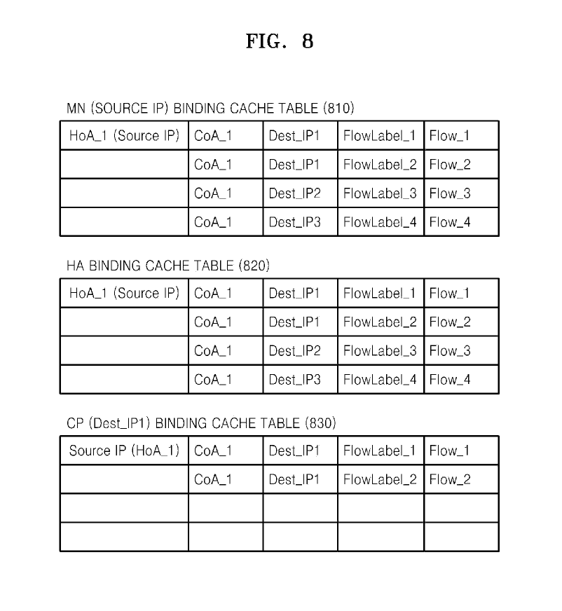

Finally, the home agent 507 determines whether the QoS can be provided (S590). If the QoS can be provided, a conventional L3 handover process is performed using additional information in the BU message (S591). In this case, information regarding the location of the mobile terminal 501, which is generated by the home agent 507 following a method of guaranteeing flow-based QoS constitutes session flow information such as a home agent binding cache table 820 (see FIG. 8). The mobile terminal 501 receiving a binding acknowledgement (BA) message constructs a mobile terminal binding cache table 81 0 illustrated in FIG. 8 according to a conventional mobile IPv6. If the QoS cannot be provided, the home agent 507 transmits an error message so as to remove the flow cache from the preceding routers and the flow list from the mobile terminal 501 (S592).

FIG. 6 is a diagram illustrating a method of setting a QoS path between a target network and a correspondent terminal by using flow information according to an embodiment of the present invention. In detail, FIG. 6 illustrates a method of setting an optimum path guaranteeing QoS (a shortest path between a mobile terminal in a target network and a correspondent terminal) by using a flow list and a flow cache described above with reference to FIG. 4 when the mobile terminal moves to the target network.

In the method of setting a flow-based QoS path between a mobile terminal in a target network and a correspondent terminal in order to set an L3 handover path guaranteeing flow-based QoS in a mobile IPv6 network, the mobile terminal transmits flow information of the mobile terminal to a router in a path between the mobile terminal in the target network and the correspondent terminal by adding a hop-by-hop extension header to a binding update (BU) message; and then the router receiving the BU message determines whether flow-based QoS that the mobile terminal requests can be provided, and then if the flow-based QoS can be provided, transmits the BU message to a router at the next hop and constructs a flow cache storing the flow information.

More specifically, referring to FIG. 6, as described above with reference to FIG. 4, a flow cache is constructed in an access router 602 in a target network (S611) and a flow list is constructed in a mobile terminal 601 (S612).

The mobile terminal 601 which has moved to the target network starts path optimization guaranteeing flow-based QoS in order to establish direction communication with a correspondent terminal 608 in a correspondent network (S613). The mobile terminal 601 creates a BU message based on a CoA allocated to the mobile terminal 601 in the target network and directly transmits the BU message to the correspondent terminal 608 according to a conventional L3 handover process (S614). In order to provide the CoA to the correspondent terminal 608 in the correspondent network, session flow information constituting a flow list is transmitted by adding a hop-by-hop extension header to a binding update (BU) message defined in a mobile IPv6.

The access router 602 in the target network compares the session flow information contained in the hop-by-hop extension header of the BU message with the flow cache stored in the access router 602 (S620). If the session flow information and the flow information of the flow cache are the same, the access router 602 forwards the BU message to a router at the next hop, i.e., a boundary router 603 in the target network (S621). If the session flow information and the flow information of the flow cache are not the same, the access router 602 transmits an error message to the mobile terminal 601 in order to remove the flow list from the mobile terminal 601 and remove the flow cache from the access router 602 (S622).

The boundary router 603 determines whether flow-based QoS can be provided, based on the flow information in the hop-by-hop extension header of the BU message verified by the access router 602 (S630). If a resource for providing the QoS is present, a session flow cache in a service session is constructed and the BU message is transmitted to the next hop (S631). If no resource for the QoS is present, the boundary router 603 sends an error message to the preceding router in order to remove the session flow cache from routers in a path between the boundary router 603 and the mobile terminal 601 and the flow list from the mobile terminal 601 (S632).

In FIG. 6, in order to avoid crosstalk with other networks as illustrated in FIG. 1, it is assumed that the target network is connected to a second core router 604 and connected to the correspondent network via a router not shown in FIG. 1, e.g., a third core router 605.

The operations of the routers 604, 605, 606, 607 are as described above. That is, each of the routers 604, 605, 606, and 607 determines whether the QoS can be provided (S640, S650, S660, S670). If the QoS can be provided, each of the routers 604, 605, 606, and 607 constructs a flow cache and transmits a BU message to the following router (S641, S651, S661, S671). If the QoS cannot be provided, each of the routers 604, 605, 606, and 607 transmits an error message to the preceding router SO as to remove the flow cache from the preceding routers and the flow list from the mobile terminal 501 (S642, S652, S662, S672).

Finally, the correspondent terminal 608 that is providing a service to the mobile terminal 601 determines whether the QoS can be provided (S680). If the QoS can be provided, a conventional L3 handover process is performed using an additional message contained in the BU message (S681). In this case, binding information of the mobile terminal 610 generated by the correspondent terminal 608 following a method of guaranteeing flow-based QoS constitutes session flow information such as a correspondent terminal binding cache table 830 (see FIG. 8). The mobile terminal 601 receiving a binding acknowledgement (BA) message constructs the mobile terminal binding cache table 810 illustrated in FIG. 8 according to a conventional MIPv6. If the QoS cannot be provided, the correspondent terminal 608 transmits an error message in order to remove the flow cache from the preceding routers and the flow list from the mobile terminal 601 (S682).

FIG. 7 illustrates the generation of flow information 710, and construction of a flow list 720, and a flow cache 730 of a mobile terminal according to an embodiment of the present invention. The methods illustrated in FIGS. 2 through 6 are based on the flow information 710, the flow list 720, and the flow cache 730.

Referring to FIG. 7, the session flow information 710 is generated and exchanged between the mobile terminal and an access router in order to transmit flow-based QoS information, the session flow list 720 is constructed in the mobile terminal based on the flow information 710, and the session flow cache 730 is constructed in a plurality of routers and a receiving terminal in a predetermined path, based on the flow information 710. The elements of the flow list 720 and the flow cache 730 mean values of regions defined in an IPv6 packet header, and an element, ‘Idle_Timer’ is a timer value for maintaining flow information in each session.

FIG. 8 illustrates various binding cache tables available for a mobile IPv6 according to embodiments of the present invention. Binding cache information is available when a mobile terminal moves to a target network as described above with reference to FIGS. 4 through 6.

Referring to FIG. 8, a mobile terminal MN binding cache table 810 is constructed in the mobile terminal when the mobile terminal moves to the target network, a home agent HA binding cache table 820 is constructed in a home agent, and a correspondent terminal CN binding cache table 830 is constructed in a correspondent terminal.

FIG. 9 illustrates an extended structure of a data packet 900 according to an embodiment of the present invention. Referring to FIG. 9, the data packet 900 available for use in the methods illustrated in FIGS. 2 and 3 contains a hop-by-hop extension header 910. The hop-by-hop extension header 910 is used to transmit session flow information to a plurality of network nodes in a path between a mobile terminal and a plurality of routers.

FIG. 10 is a diagram illustrating an error message 1010 according to an embodiment of the present invention. Referring to FIG. 10, the error message 1010 is contained in a QoS information acknowledgement (ACK) message 1000 so that the error message 1010 can be transmitted when QoS information is not available between a mobile terminal and a plurality of routers in the methods illustrated in FIGS. 2 through 6. Each network node can use an ICMPv6 message as the error message 1010.

FIG. 11 illustrates the structure of a binding update (BU) message 1100 according to an embodiment of the present invention. The BU message 1100 is transmitted to a home agent and a correspondent terminal by a mobile terminal when the mobile terminal moves to a target network in the methods of FIGS. 4 through 6. The BU message 1100 that is defined in a mobile IPv6 contains a hop-by-hop extension header 1110, and flow information constituting a session information list so that the BU message 1100 can be transmitted to a plurality of network nodes in a predetermined path.

The present invention can be embodied as computer readable code in a computer readable medium. The computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as computer readable code in the distributed system.

According to the present invention, even if a mobile terminal moves from a home network to a target network, an IPv6-based L3 handover service can be provided while guaranteeing end-to-end flow-based QoS between the mobile terminal and a correspondent terminal, e.g., an integrated service (IntServ).

Also, according to the present invention, end-to-end flow-based QoS can be continuously provided in an IPv6-based wired and wireless integrated service network even if a service terminal moves to a target network other than a home network. Accordingly, the present invention can be applied to both a mobile service environment that various types of IP-based service terminals will request, and a future service environment seeking Triple Play Services (TPS), such as data, speech, and images.

Also, according to the present invention, it is possible to provide improved QoS than a differentiated service (DiffServ) that provides only class-based QoS in the IPv6-based Internet. Accordingly, it is possible to solve a problem of an integrated service (Intserv) providing flow-based QoS, i.e., a restriction to the expandability for large-scale network application.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of setting a layer 3 handover path guaranteeing flow-based QoS (quality of service) in a mobile IPv6 (Internet protocol version 6) network, the method comprising:
receiving verification of QoS-related information and flow information of a mobile terminal in a home network from a network management system, constructing a flow list storing the verified flow information in the mobile terminal, and constructing a flow cache storing the verified flow information in an access router in the home network;
transmitting the flow information by using a hop-by-hop extension header of a packet that is to be transmitted in order to allow a plurality of routers in a path between the mobile terminal and a correspondent terminal to sequentially construct a flow cache;
if the mobile terminal moves to a target network, reconstructing the flow list of the mobile terminal and the flow cache in the access router in the target network, between the mobile terminal and an access router of the target network;
adding the hop-by-hop extension header to a binding update message in order to allow a plurality of routers in a path between the mobile terminal which has moved to the target network and the access router in the home network to sequentially construct the flow cache; and
adding the hop-by-hop extension header to a binding update message in order to allow a plurality of routers in a path for establishing direct communication between the mobile terminal and the correspondent terminal to sequentially construct the flow cache.

2. A method of constructing flow-based QoS (quality of service) information of a mobile terminal in a home network in order to set a layer 3 handover path to guarantee flow-based QoS in a mobile IPv6 (Internet protocol version 6) network, the method comprising:
the mobile terminal setting a wireless section resource with a base station in the home network and requesting an access router in the home network to provide the QoS information;
the access router in the home network receiving verification of QoS-related information and flow information of the mobile terminal from a network management system in the home network;
constructing a flow cache storing the verified flow information in the access router in the home network; and
constructing a flow list storing the verified flow information in the mobile terminal.

3. The method of claim 2, wherein each of the flow cache and the flow list further comprises a timer value for maintaining flow information for each session.

4. A method of setting a QoS (quality of service) path between a mobile terminal and a correspondent terminal in a home network by using flow information in order to set a layer 3 handover path guaranteeing flow-based QoS in a mobile IPv6 (Internet protocol version 6), the method comprising:
the mobile terminal adding a hop-by-hop extension header to a data packet that is to be transmitted and then providing flow information of the mobile terminal to a router between the mobile terminal and the correspondent terminal;
the router receiving the data packet determining whether it is possible to provide a flow-based QoS guarantee that the mobile terminal requests; and
if the flow-based QoS guarantee is to be provided, the router transmitting the data packet to a router at a next hop and constructing a flow cache storing the flow information.

5. The method of claim 4, further comprising:
if the flow-based QoS guarantee is not to be provided, transmitting an error message to the access router in the home network in order to remove the flow cache from a plurality of routers in a path between the mobile terminal and the access router in the home network; and
the mobile terminal removing the flow list storing the flow information.

6. The method of claim 5, wherein the error message comprises an ICMPv6 (Internet Control Message Protocol for IPv6) message.

7. A method of generating flow-based QoS (quality of service) information of a mobile terminal which has moved to a target network in order to set a layer 3 handover path guaranteeing flow-based QoS in a mobile IPv6 (Internet protocol version 6) network, the method comprising:
the mobile terminal reconstructing a flow list storing flow information if an access router in a home network allocates a CoA (Care of Address) is allocated to the mobile terminal;
the mobile terminal setting a wireless section resource with a base station in the target network and requesting an access router in the target network to provide QoS information; and
if the access router in the target network is to provide flow-based QoS, the access router in the target network informing the mobile terminal that the QoS information is recognized, and then constructing a flow cache storing the flow information.

8. The method of claim 7, further comprising:
if flow-based QoS is not to be provided, the access router in the target network transmitting an error message to the mobile terminal in the target network in order to remove the flow cache from a plurality of routers in a path between the mobile terminal and the access router in the target network; and
the mobile terminal removing the flow list storing the flow information.

9. The method of claim 8, wherein the error message comprises an ICMPv6 (Internet Control Message Protocol for IPv6) message.

10. A method of setting a QoS (quality of service) path between a mobile terminal in a target network and an access router in a home network by using flow information in order to set a layer 3 handover path for flow-based QoS guarantee in a mobile IPv6 (Internet protocol version 6) network, the method comprising:
the mobile terminal adding a hop-by-hop extension header to a binding update message and transmitting the binding update message to a router in a path between the mobile terminal in the target network and the access router in the home network so as to deliver flow information of the mobile terminal;
the router which has received the binding update message determining whether flow-based QoS that the mobile terminal requests is to be provided; and
if the flow-based QoS is to be provided, the router delivering the binding update message to a router at a next hop, and then constructing a flow cache storing the flow information.

11. The method of claim 10, further comprising:
if the flow-based QoS is not to be provided, delivering an error message to an access router in the target network in order to remove the flow cache from a plurality of routers in a path between the router in the home network and the access router in the target network; and
the mobile terminal removing a flow list storing the flow information.

12. The method of claim 11, wherein the error message comprises an ICMPv6 (Internet Control Message Protocol for IPv6) message.

13. A method of setting a flow-based QoS (quality of service) path between a mobile terminal and a correspondent terminal in a target network in order to set a layer 3 handover path for flow-based QoS guarantee in a mobile IPv6 (Internet protocol version 6) network, the method comprising:
the mobile terminal adding a hop-by-hop extension header to a binding update message and transmitting the binding update message to a router in a path between the mobile terminal and the correspondent terminal in the target network in order to deliver flow information of the mobile terminal;
the router which has received the binding update message determining whether flow-based QoS that the mobile terminal requests is to be provided; and
if the flow-based QoS is to be provided, the router delivering the binding update message to a router at a next hop and then constructing a flow cache storing the flow information.

14. The method of claim 13, further comprising:
If the flow-based QoS is not to be provided, transmitting an error message to an access router in the target network in order to remove the flow cache from a plurality of routers in a path between the access router in the target network and the router which has received the binding update message; and
the mobile terminal removing a flow list storing the flow information.

15. The method of claim 14, wherein the error message comprises an ICMPv6 (Internet Control Message Protocol for IPv6) message.
